(19) United States
(12) Patent Application Publication
(10) Pub. No.: US 2021/0061329 A1
(43) Pub. Date: Mar. 4, 2021

(54) Hand Propelled Cart

(71) Applicant: Iordanis Giannopoulos, Johannesburg (ZA)

(72) Inventor: Iordanis Giannopoulos, Johannesburg (ZA)

(21) Appl. No.: 16/712,434

(22) PCT Filed: Jul. 26, 2018
(86) PCT No.: PCT/ZA2018/050041

§ 371 Date: Dec. 12, 2019

(30) Foreign Application Priority Data
Jul. 28, 2017 (ZA) 2017/05130

(51) Int. Cl. B62B 1/18

(52) U.S. Cl. CPC B62B 1/186

(57) ABSTRACT

The invention provides a hand propelled cart which includes one or more wheel member mounted on an axle wherein the axle is operatively associated with a pair of handle members which are attached to a support frame for a load bearing receptacle or the load bearing receptacle directly, wherein the one or more wheel is located below a central zone of the load bearing receptacle so that, in use, the one or more wheel is below the load bearing receptacle and biased towards the centre of a load in the receptacle.

### FIELD OF THE INVENTION

The invention relates to hand propelled carts, also known as a wheelbarrow.

### BACKGROUND TO THE INVENTION

As stated in U.S. Pat. No. 4,767,127, the first major contribution of ancient mankind to today's technology was the discovery of the wheel. This monumental event was no doubt closely followed by the invention of the first crude wheelbarrow. Given the early origins of the wheelbarrow, it should not come as a startling revelation that down through the ages mankind has continually strived to improve upon this ancient and somewhat humble wheeled apparatus.

There have been many attempts over the eons to develop a better wheelbarrow, for example, these prior art constructions may be seen by reference to the following U.S. Pat. Nos. 736,697; 1,407,690; 1,735,527; and, 2,598,261.

As can be seen by reference to the aforementioned patents, while all of the prior art wheelbarrows are more than adequate for their intended purpose and function, they certainly do not represent the culmination of the inventive process with respect to this particular area of technology. As a consequence of the foregoing situation, continuing attempts have been undertaken to render improvements to the basic wheelbarrow construction, and the present invention represents the end product of only one of those continuing attempts.

A typical wheelbarrow includes a wheel mounted on an axle wherein the axle is operatively associated with a pair of handle members which are attached to a support frame for a load bearing receptacle and wherein the axle is mounted forward of the load bearing receptacle such that a load in the receptacle is suspended between the axle of the wheel and the handle members.

### SUMMARY OF THE INVENTION

The present invention provides a hand propelled cart, also known as a wheelbarrow, which includes one or more wheel members mounted on an axle wherein the axle is operatively associated with a pair of handle members which are attached to a support frame for a load bearing receptacle or the load bearing receptacle directly, wherein the one or more wheel is located below a central zone of the load bearing receptacle so that, in use, the one or more wheel is below the load bearing receptacle and biased towards the centre of a load in the receptacle.

The wheel may be an enlarged wheel having a rubber or polymeric running surface.

There may be more than one wheel mounted adjacent each other on the same axle, as required by the duty.

The support frame may be tubular steel frame.

The support frame may be a wooden, polymeric, or composite frame. The frame may be tubular or solid beam or rod.

The load bearing receptacle may be in the form of a bucket, or any other shape required for carrying the particular materials to be transported, for example, sand, stone, goods, or the like.

The load bearing receptacle may be made of steel, aluminium, composite material, or any other suitable material.

It is believed to be an advantage of the invention that a substantial majority or even a substantial entirety of the load is borne by the wheel located below the load bearing receptacle rather than being carried by the arms of the user of the wheelbarrow as is the case in conventional wheelbarrows.

### DESCRIPTION OF AN EMBODIMENT OF THE INVENTION

The invention will now be described, by way of non-limiting example only, with reference to the accompanying photographic representations of a prototype.

In the representations,

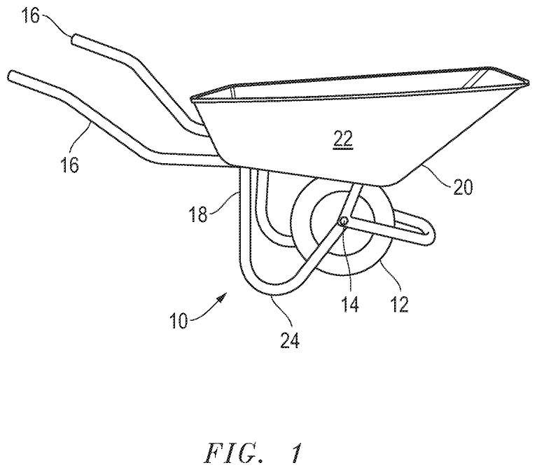

FIG. 1 shows a side view photograph of a prototype of the hand propelled cart of the invention showing the position of the wheel under the load bearing receptacle;

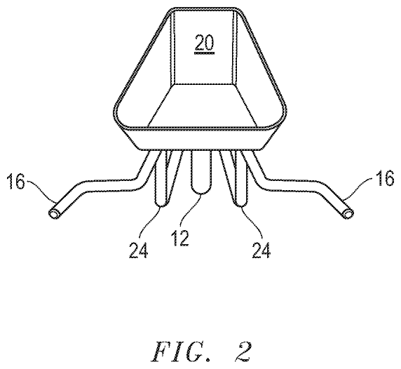

FIG. 2 shows a rear view of the hand propelled cart of FIG. 1; and

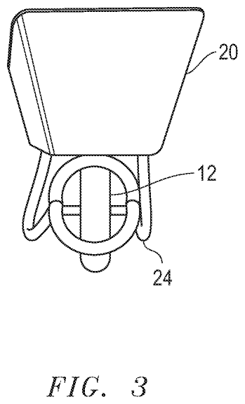

FIG. 3 shows a front view of the hand propelled cart of FIG. 1.

In the figures, a hand propelled cart 10 broadly in accordance with the invention, also known as a wheelbarrow, is shown.

The wheelbarrow 10 has a wheel 12 mounted on an axle 14 wherein the axle 14 is operatively associated with a pair of handle members 16 which are attached to a support frame 18 for a load bearing receptacle 20 or the load bearing receptacle 20 directly, wherein the wheel 12 is located below a central zone 22 of the load bearing receptacle 20. In the embodiment shown, the central zone 22 may be thought of as a volumetric minority of the receptacle 20 about which the overall load of the receptacle is centered. For example, when loaded with an aggregate or other material and with the handle members 16 lifting the support frame 18 and ground engaging portion 24 from the ground, the receptacle 20 would be no more biased to tilt forward or rearward relative the axle 14. That is, in use, the wheel 12 is below the load bearing receptacle 20 with bias being directed at the central zone 22 itself. The support frame 18 is made from a steel tubular frame having the noted ground engaging portion 24 which allows the wheelbarrow to be placed in a rest position when not being propelled by the user.

The wheel 12 is an enlarged wheel having a rubber running surface.

The load bearing receptacle 20 is in the form of a steel bucket, as shown, as required for carrying the particular materials to be transported, for example, sand, stone, goods, or the like.

Thus, in use, when the receptacle 20 is filled with material such as sand or stone and a worker must transport said materials to the point of use, the weight of the sand or stone rests on the wheel 12, supported by the axle 14 from the support frame 18, and is for the most part not carried by the worker from the handles 16 while he is pushing the wheelbarrow 10. This makes the transportation of such heavy materials much easier than the use of a conventional wheelbarrow wherein the wheel is fore of the receptacle and the load hangs between the axle of the wheel and the arms of the user so that the user effectively carries the weight and pushes the wheelbarrow.

It is believed that the use of the new wheelbarrow will significantly reduce the work load on workers and thus increase productivity where wheelbarrows are used.

1. (canceled)

2. (canceled)

3. (canceled)

4. (canceled)

5. (canceled)

6. (canceled)

7. (canceled)

8. (canceled)

9. (canceled)

10. A hand propelled cart comprising:
a load bearing receptacle for accommodating a material;
at least one wheel located below the receptacle for interface with a ground surface;
an axle through a center portion of the wheel and structurally coupled to the receptacle, the axle to support rotation of the wheel about the axle for movement of the cart over the surface; and
a central zone of the receptacle encompassing a load center thereof and located immediately over the axle such that during the rotation of the wheel, load bias of the cart is substantially favored at the axle over forward and rearward positions thereof.

11. The cart of claim 10, wherein the wheel includes a polymeric running surface that is one of a rubber and another polymeric material.

12. The cart of claim 10, wherein the at least one wheel comprises multiple wheels mounted adjacent each other about the axis.

13. The cart of claim 10, wherein the structural coupling is a tubular steel support frame.

14. The cart of claim 10, wherein the structural coupling is selected from a group consisting of a wood support frame, a polymeric support frame and a composite support frame.

15. The cart of claim 14, wherein the structural coupling is a support frame that is one of tubular construction, solid beam construction and rod construction.

16. The cart of claim 10, wherein the load bearing receptacle is one of a bucket and another shape tailored to the material type accommodated.

17. The cart of claim 16, wherein the load bearing receptacle is constructed of a material selected from a group consisting of metal, steel, a plastic and wood.
